(19) United States
(12) Patent Application Publication
(10) Pub. No.: US 2026/0120964 A1
(43) Pub. Date: Apr. 30, 2026

(54) ENERGY STORAGE RACK AND FRAME STRUCTURE THEREFOR WITH VIBRATIONAL ABSORBER FUNCTION

(71) Applicant: Skeleton Technologies GmbH, MARKRANSTÄDT (DE)

(72) Inventors: Anton TUZIUK, KAILA (EE); Sinan YILDIRIM, BERLIN (DE)

(21) Appl. No.: 19/360,273

(22) Filed: Oct. 16, 2025

(30) Foreign Application Priority Data
Oct. 30, 2024 (LU) LU508744

(51) Int. Cl. H01G 11/10; H01G 11/18

(52) U.S. Cl. CPC H01G 11/10; H01G 11/18

(57) ABSTRACT

A cuboidal frame structure configured for absorbing and/or damping seismic vibration. The frame structure is suitable for an energy storage rack of an energy storage system. The frame has a bottom frame integrally formed as a single member and having a plurality of column brackets, that protrude in a vertical direction upward, for aligning a column in parallel to a vertical direction. The frame has a plurality of columns mounted to the base frame via the column brackets. Each column is formed as a hollow profile. A top frame is mounted to each column. The columns cooperatively provide a plurality of mounting positions for receiving and mounting energy storage modules. Passive cooling can be enhanced by locating units below the bottom frame.

### CROSS-REFERENCES TO RELATED APPLICATIONS

This application claims the benefit of Luxembourg Patent Application Number LU508744 filed on Oct. 30, 2024, the entire disclosure of which is incorporated herein by way of reference.

### FIELD OF THE INVENTION

The invention relates to a cuboidal frame structure for an energy storage rack of an energy storage system. The invention further relates to an energy storage rack.

### BACKGROUND OF THE INVENTION

In this disclosure the terms “high voltage” (HV), “low voltage” (LV) and “extra low voltage” (ELV) follow the generally accepted definition of the International Electrical Commission according to IEC 61140:2016 “Protection against electric shock-Common aspects for installation and equipment”. Thus, the term “high voltage” designates voltages above 1000 V for alternating current (AC) and above 1500 V for direct current (DC), the term “low voltage” designates voltages smaller than or equal to 1000 V for AC and smaller than or equal to 1500 V for DC, and the term “extra low voltage” designates voltages smaller than or equal to 50 V for AC and smaller than or equal to 120 V for DC.

US 2004/0 057 211 A1 discloses a rack with liquid cooling system.

EP 3 661 339 A1 discloses a rack adapted for receiving one or more components. The rack includes a backplane, a pair of side panels extending from the backplane and internal support members on each side to receive and mechanically guide an initial alignment of components upon their initial insertion in the rack. A pair of male connectors mounted to the backplane is configured to mate with a corresponding pair of female connectors of each component to mechanically guide a final alignment of each component when the component is further inserted in the rack. Mechanical guidance may also be provided by, or supplemented with, a connection capable of providing liquid cooling to the rack. A system including the rack and the component inserted in the rack is also disclosed.

Such racks, colloquially also non as 19″-racks are a standard component in data centers for mounting, supplying, and cooling servers and other IT equipment. Recently, these types of racks have also received much attention in the field of energy storage, even in high-voltage systems. These racks can be used to build up large strings of fast charging and discharging capacitor banks that can be used in high-voltage DC systems in particular for static synchronous compensation (STATCOM).

Due to the sensitive nature of these systems, certain requirements must be met regarding seismic vibration damping and mitigation as defined in IEEE Recommended Practice for Seismic Design of Substations, IEEE 693-2018.

### SUMMARY OF THE INVENTION

It is an object of the invention to provide a rack structure that has an improved mitigation of vibrations. The object may be achieved by the subject-matter of one or more embodiments described herein.

The invention provides a cuboidal frame structure configured for absorbing and/or damping seismic vibration, the frame structure being suitable for an energy storage rack of an energy storage system, the frame structure comprising:
a bottom frame that is integrally formed as a single member, the bottom frame having a plurality of column brackets that protrude in a vertical direction upward and are configured for aligning a column in parallel to a vertical direction;
a plurality of columns, the columns being mounted to the base frame via the column brackets, each column formed as a hollow profile;
a top frame that is mounted to each column,
wherein the columns cooperatively provide a plurality of mounting positions that are configured for receiving and mounting energy storage modules.

The integral formed bottom frame can provide more stability due to higher stiffness. Furthermore, the transfer of vibration is different compared to composite versions that are bolted together. Overall, the bottom frame allows for a better and easier fulfillment of the requirements regarding vibration.

Preferably, the bottom frame is integrally formed by welding a plurality of components or by casting. For easier construction, the bottom frame can be welded from plate or (hollow) bar materials. It is also possible to cast the bottom frame.

Preferably, each column is attached to the bottom frame and/or top frame by a plurality of bolt fasteners. While the bottom frame is a single member that is integrally formed the connection of the columns allows for a little bit of movement, which helps to provide damping at the desired frequencies.

Preferably, the top frame is integrally formed as a single member, preferably by welding a plurality of components or by casting. Preferably, the top frame is also integrally formed. This further improves stiffness and the transfer of vibrational energy such that the desired vibration absorption properties are improved.

Preferably, at least one column bracket has a first leg portion that extends in parallel to a shorter side of the bottom frame and a second leg portion that extends in parallel to a longer side of the bottom frame, preferably substantially orthogonal relative to the first leg portion. Preferably, the first and second leg portions are in contact with and/or fastened to the respective column, preferably the case sheet member. Preferably, the column bracket is formed at a corner portion of the bottom frame. Preferably, at least one column bracket is formed at an edge portion of the bottom frame. Preferably, the column bracket includes a third leg portion that extends parallel to the first leg portion with a space there between. Preferably, two column members that are fastened to the column bracket engage the first and third leg portions as well as each other with the respective case sheet member. The column brackets prevent the columns from a two large deviation from their average position. The column brackets may basically function as a very stiff leaf spring that further improves the vibrational absorption in the frame structure.

Preferably, at least one column includes a case sheet member and a cover sheet member that are engaging and/or fastened to each other to form the column. The column being formed from two sheet members not only allows for easier manufacturing. It also introduces a certain amount of friction within the column, which may further improve vibrational absorber function of the frame.

Preferably, the case sheet member comprises at least three leg portions that are bent in a U-configuration to form sidewalls and a channel bottom of a channel. Preferably, the cover sheet member comprises at least two leg portions that are bent in an L-configuration and the cover sheet member closes the channel to form the hollow profile. Optionally, the case sheet member includes a flange portion that partially protrudes from one side wall inward and parallel to the channel bottom. With this configuration, a stiff column member can be produced that has the desired vibrational absorption.

Preferably, at least one column is integrally formed as a single member. Preferably, the column includes a reinforcement portion that extends parallel to a short side of the column in a cross-sectional view. In an alternative embodiment, the column can be made as a single piece of heavier duty sheet metal. Thus, a similar vibrational absorption can be achieved as the piece column having multiple parts.

Preferably, the frame structure further comprises at least one truss member that is fastened to an end portion of one column and to another end portion or middle portion to form an acute angle with the respective columns. The truss increases rigidity of the whole setup and also allows to disperse certain bending moments during vibration.

Preferably, a plurality of high-voltage isolators is fastened, preferably welded, to the bottom frame. The isolators are typically made of ceramic. Due to the integral configuration of the bottom frame, it is possible to directly mount them in a way that avoids breaking during vibration.

Preferably, the frame structure further comprises at least one installation position that is disposed below, and preferably adjacent to, the bottom frame and is configured for receiving and installing an auxiliary power module that is configured for providing auxiliary power in case of a main power outage and/or a rack controller unit that is configured to control the energy storage modules. The typically more heavy or massive modules are preferably arranged below the bottom frame and between the high-voltage isolators. Thus, the center of mass of the whole construction can be lowered, resulting in better seismic behavior.

The invention provides an energy storage rack for an energy storage system, the energy storage rack comprising a preferred frame structure and a plurality of energy storage modules configured for storing and providing electrical power, wherein the energy storage modules are mounted on the mounting positions provided by the frame structure.

Preferably, the energy storage module includes an energy storage that involves supercapacitors.

Preferably, at least one auxiliary power module and/or at least one rack controller unit is installed at the installation position. The auxiliary power modules are able to lower the center of mass in the energy storage rack, thereby improving the seismic properties. Furthermore, these modules and units typically generate the least amount of heat so that the thermal load can be reduced.

Preferably, the energy storage modules are passively cooled, preferably such that a consistent temperature gradient is formed throughout the energy storage rack. For example, passive cooling allows for a lower energy consumption, as no cooling fans need to be powered. The consistent gradient causes the energy storage cells to age more consistently leading to an improved overall lifetime and easier maintenance.

Preferably, each energy storage module includes a plurality of energy storage cells that are arranged in a pattern of hexagonally close-packed equal cylinders or in a rectangular pattern. The patterns allow for a large number of energy storage cells in the energy storage module, while allowing sufficient airflow for cooling between the energy storage cells.

Preferably, each energy storage module includes a heat sink that is disposed at an outward facing side, preferably a front side or a back side, of the energy storage module. With the heat sink being disposed on the outside, the heat is directly transported away from the module thereby further allowing the reduction of thermal load.

In some embodiments the mechanical rack comprises multiple energy storage modules. The modules may comprise supercapacitors or hybrid battery cells.

In some embodiments the vibration profile of the disclosed rack is below 33 Hz, and the rack design complies with seismic requirements according to IEEE 693:2018 moderate-level seismic input with 2% damping.

In some embodiments the rack comprises a welded beam base frame.

In some embodiments the rack features diagonal braces at the back and/or on both sides, with preferably none on the front side.

In some embodiments the rack height is kept at the minimum by moving all supplementary equipment to the sides and below the framework.

In some embodiments there are no single-purpose steel components available in the rack-preferably all components work toward strengthening the whole structure.

In some embodiments the rack is installed on a couple of HV insulators, e.g., six HV insulators—preferably one at each corner of the rack and one under each mid-section of the double rack.

In some embodiments the proposed rack includes a passive cooling mechanism that evenly distributes heat, preventing localized overheating and ensuring the reliability and longevity of electronic components within the energy storage system.

In some embodiments the temperature distribution has a consistent gradient throughout the rack.

The energy storage rack's proposed mechanical design, i.e., supercapacitor rack, is seismic hazard proof and complies with the IEEE 693:2018 seismic profile standards. Apart from its earthquake-proof design, the rack may also comprise natural cooling and preferably has no enclosure.

The proposed rack design is most suitable in high-voltage DC (HVDC) systems, especially in static synchronous compensators (STATCOM) or enhanced-STATCOM (ESTACOM) systems.

Typically one rack unit comprises a double rack containing with space for 20 modules, master (module) controllers, bypass subassembly, auxiliary (“aux.”) supply, and rack controller equipment.

The rack unit framework dimensions are more or less standardized as 1200 mm×600 mm×2100 mm (W×D×H, excluding the HV insulators). Energy storage system (ESS) modules are preferably designed to be installed in a rack with 19-inch slider spacing, which is also the major constraint that generally determines the overall rack dimensions. This is the widespread form factor that is used, thus the disclosure focuses on this implementation. However, it should be noted that other dimensioning is generally possible though unusual.

The rack framework is preferably designed to fit 20 ESS modules. The modules can be installed on slidable brackets and fixed with screws at the front face. The framework may include two major subassemblies-a welded base frame and a sheet metal framework (in particular the columns). Preferably, the rack is open with no walls. Thus, the rack is typically capped at an IP00 rating, meaning a level of protection where there is no special protection against ingress of solids or liquids.

The rack features no additional or optional empty space that is not filled with the required equipment. In other words, nearly the whole rack volume is equipped with components without wasted space. To be able to comply with the seismic profile, the height of the rack is kept preferably at the absolute minimum and all supplementary equipment is preferably installed on the sides and below the rack, e.g., between the insulators.

Keeping the rack height to a minimum also solves potential logistics issues like transportation limitations and maintainability (e.g., less equipment to reach with a mobile platform). The rack is installed on HV insulators-preferably one at each corner of the rack and two under the mid-section of the double rack. The auxiliary power system and rack controller are preferably installed underneath the rack base frame between the HV insulators. This was found to be the optimal location in seismic simulations.

The master controller may perform the voltage balancing of the cells within the rack. It can be installed either at the very top or bottom slot. The master controller may be at the very top. In this double-track system, the auxiliary supply units are preferably conceptually placed below the rack for reasons related to seismic design and stability. The grounding point, which is generally to be used during maintenance, is located at the center of the base frame.

Seismic design considerations involve enhancing stability, e.g., by placing the auxiliary units below. This lowers the system's center of gravity, thereby improving stability and resistance to seismic activity.

The E-STATCOM system is designed to withstand the moderate profile of the IEEE 693:2018 seismic profile. To ensure compliance with the standard, a series of preliminary seismic-specific simulations were performed during the concept phase which resulted in the embodiments disclosed herein.

Two simulation targets were set in accordance with the standard tests. A first target is that the lowest eigenfrequency in the horizontal direction is above 33 Hz. In case there is an eigenfrequency in the vertical direction below 33 Hz, the embodiment is still acceptable. The eigenfrequency matches the requirements of IEEE 693-2018, otherwise, the vibration load may get amplified, which may cause damage to the system and ultimately lead to destructive resonance events.

A second target is that no failure is seen at the rack regarding the provided vibration profile. The vibration profile exists below 33 Hz. Any resonance below 33 Hz will generally amplify the seismic input. The simulation results show that the rack design complies with seismic requirements according to IEEE 693:2018 at moderate-level seismic input with 2% damping. The measurements described herein generally shift the resonance frequency. No damage is observed at sine-sweep fatigue calculation.

The simulation resulted in some features that helpful in the context of seismic design. These features include a welded beam base frame, diagonal braces at the back and sides of the framework, HV insulators at the corners and optionally the mid sections, rack height kept at a minimum especially by moving all supplementary equipment to the sides and below the framework, and/or no single-purpose steel components-all components (cooperatively) work toward strengthening of the whole structure.

In addition, thermal management is considered in this disclosure. A thermal simulation was conducted to evaluate the effectiveness of the current cooling concept for the E-STATCOM double rack design. Efficient thermal management is important for ensuring the reliability and longevity of electronic components within the ESS. For the simulation, a simplified rack model can be used to reduce the simulation time while having sufficient model accuracy.

Analysis conditions include a simplified double rack model for simulation, a module count of 20 ESS modules, a master controller and switchgear enclosures included (on top) for worst-case air movement restriction, a load of 31 A rms on the ESS modules only, a module balancer temperature of 85° C., a module power loss of about 15 W to 18 W (cells and busbars only, balancer excluded), module at end of life (EoL) conditions, equivalent series resistance ESR of 200% of rated 1 s ESR, total power loss of the rack about 300 W (cells and busbars only, balancers excluded), ambient temperature of 26° C., cooling type natural convection, temperature criteria involves maximum cell temperature, and rack IP class of IP00.

Under these and similar conditions, the temperature distribution within the double rack is typically a consistent gradient, with the highest temperatures occurring near the top of the rack due to natural convection.

The maximum cell temperature observed was around 48° C., which is within the acceptable operational limits for the components. This suggests that the passive cooling is sufficient to manage the heat generated by the ESS modules. The temperature distribution is comparatively uniform across the modules, without significant hotspots. Thus, with the passive cooling approach heat can be evenly distributed, while localized overheating is prevented.

A detailed analysis of individual modules, particularly the third module from the top, shows a higher temperature at the center compared to the edges. This core-to-edge gradient is typical in such setups and can be managed within safe limits.

The lifetime simulations conducted after thermal simulations demonstrate that the passive convective cooling configuration for the E-STATCOM double-rack is effective. The studies focused on assessing the temperature rise within the modules and the thermal resistance (Rₜₕ).

Key findings from the thermal study are discussed for temperature rise, thermal resistance, and lifetime expectation. The maximum cell temperature observed during the simulations was around 48° C. This temperature is well within the acceptable operational limits for the components. The thermal simulations revealed the highest thermal resistance (Rₜₕ) value of 1.34 K/W. This value is indicative of efficient heat dissipation, with the system effectively managing the thermal load generated by the modules. The Rₜₕ value used in lifetime simulations is chosen according to the highest module temperature value. Based on the temperature rise and the calculated thermal resistance, the expected lifetime of the system components is expected to be more than 20 years under ambient temperature conditions at 26° C.

In the double-rack design, precise temperature monitoring can be necessary for ensuring the optimal performance and longevity of the modules. The placement of temperature sensors is strategically designed to capture accurate thermal data from critical points within the system. The sensors are placed on the printed circuit board (PCB) rather than directly on the cells themselves. Each cell is preferably numbered with a so called cell index, and temperature sensors are positioned at key locations to monitor the thermal state. Specifically, bottom-side temperature sensors and top-side temperature sensors are used preferentially. There may also be a current measurement (CM) sensor for measuring the current of the PCB busbar.

Given the effective thermal management in this configuration, no additional cooling is required, as the passive cooling method, utilizing natural convection, is sufficient to maintain safe operating temperatures. As a result the longevity and availability of the electronic components can be ensured.

Furthermore, the lack of a closed housing or casing contributes to cost-effectiveness, improved cooling efficiency, reduced complexity, and may achieve a lifetime of 20 years of the system. Additional costs, added weight, operational complexities, and potential environmental impacts can also be reduced or avoided compared to forced cooling or liquid cooling solutions.

The lack of liquid cooling further decreases failure rates as a potential failure point can be eliminated. Overall, this approach helps to ensure a reliable, efficient, and sustainable thermal management solution for E-STATCOM double-rack systems.

### BRIEF DESCRIPTION OF THE DRAWINGS

Embodiments of the invention are described in more detail with reference to the accompanying schematic drawings that are listed below

FIG. 1 depicts an embodiment of an energy storage rack;

FIG. 2 depicts an embodiment of a bottom frame;

FIG. 3 depicts another embodiment of a bottom frame;

FIG. 4 depicts a detail of the columns attached to the bottom frame;

FIG. 5 depicts an embodiment of a top frame;

FIG. 6 depicts a first variant of a column;

FIG. 7 depicts a second variant of a column;

FIG. 8 depicts a third variant of a column;

FIG. 9 depicts another embodiment of an energy storage rack;

FIG. 10 depicts a spectral acceleration graph of the energy storage rack;

FIG. 11A depicts a lateral view of thermal simulation results;

FIG. 11B depicts a front view of the thermal simulation results;

FIG. 12 depicts a horizontal cross-section of the thermal simulation results;

FIG. 13 depicts a table of the thermal simulation results; and

FIG. 14 illustrates the thermal sensor positioning for an energy storage module.

### DETAILED DESCRIPTION OF THE PREFERRED EMBODIMENTS

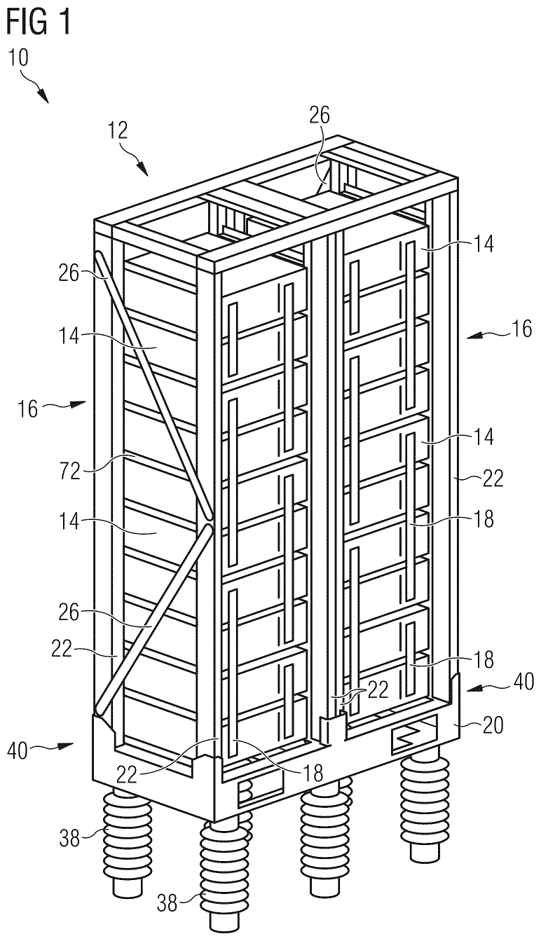

Referring to FIG. 1 an energy storage rack 10 is depicted. The energy storage rack 10 comprises a frame structure 12. The frame structure 12 supports a plurality of energy storage modules 14 that are mounted to the frame structure in predetermined mounting positions 16. The energy storage modules 14 are electrically and mechanically connected by a plurality of busbars 18.

The frame structure 12 comprises a bottom frame 20. The bottom frame 20 supports a plurality of vertical columns 22. The columns 22 are held together at the top by a top frame 24. The frame structure 12 may further include a plurality of trusses 26 that are mounted between different columns 22.

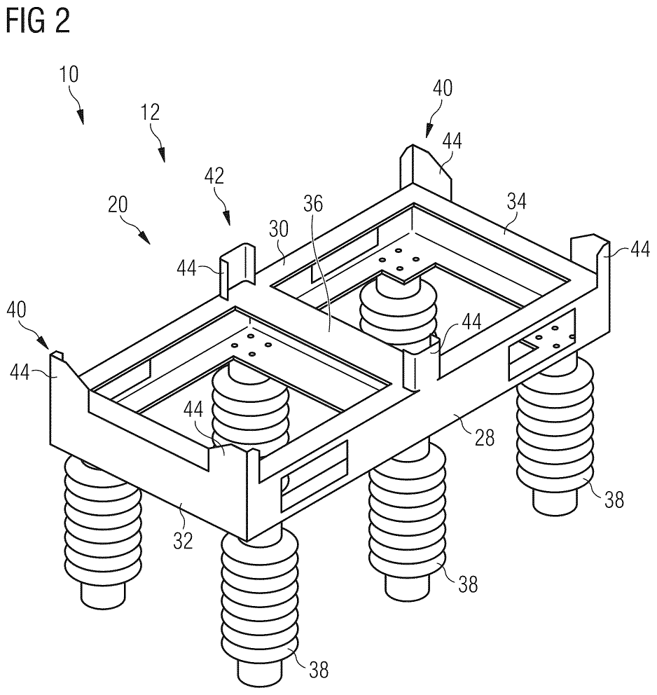

Referring to FIG. 2, the bottom frame 20 is depicted in more detail. The bottom frame 20 is integrally formed as a single member. The bottom frame 20 has a general rectangular shape. The bottom frame 20 is welded together from different parts of sheet metal. The sheet metal has preferably a thickness of at least 3 mm, preferably about 5 mm.

The bottom frame 20 has long front/back portions 28, 30 and short side portions 32, 34. Furthermore, the bottom frame 20 includes a crossbeam 36 that is parallel to the side portions 32, 34 and formed roughly in the middle.

The long front/back portions 28, 30 and the short side portions 32, 34 have a cross-section that is roughly C-shaped. These portions 28-34 may include openings for airflow.

The crossbeam 36 may have a C-shaped cross-section, although other cross-sections are possible, such as similar to an I-beam, where preferably the upper side is narrower than the bottom side.

The bottom frame 20 includes a plurality of high-voltage (HV) isolators 38. The HV isolators 38 are mounted to the bottom frame 20 via fasteners and are preferably arranged at corner portions 40 and intermediate portions 42, as shown in FIG. 2.

The bottom frame 20 includes a plurality of column brackets 44 that protrude upward. The column brackets 44 are formed on the corner and intermediate portions 40, 42. The column brackets 44 at the corner portions 40 generally have an L-shape, whereas the column brackets 44 at the intermediate portions 42 generally have a U-shape.

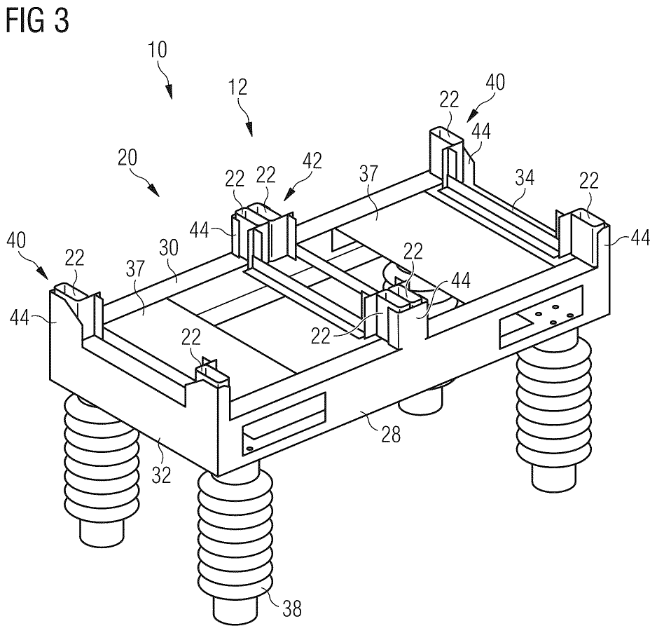

Referring to FIG. 3 another embodiment of the bottom frame 20 is depicted. Here the bottom frame has no crossbeam, but instead includes stabilization plates 37. The stabilization plates 37 can be welded to the front/back portions 28, 30, preferably the short legs of the C-shape. The bottom frame 20 includes four HV isolators 38.

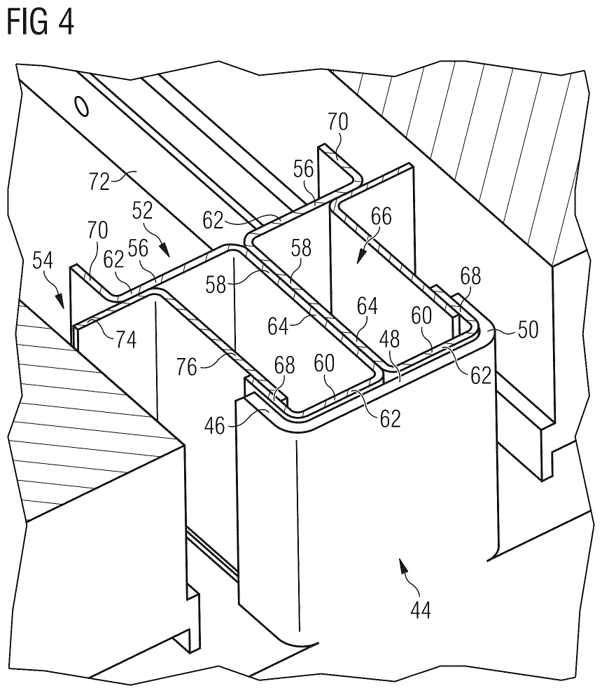

Referring to FIG. 4, the bottom frame 20 is depicted in more detail. The column bracket 44 includes a first leg portion 46, a second leg portion 48, and a third leg portion 50. The first and third leg portions 46, 50 are parallel to each other and spaced apart by the second leg portion 48. The second leg portion 48 is orthogonal to the first and third leg portions 46, 50.

The column 22 includes a case sheet member 52 and a cover sheet member 54. The sheet members 52, 54 are made of bent metal sheets with a thickness of preferably about 3 mm.

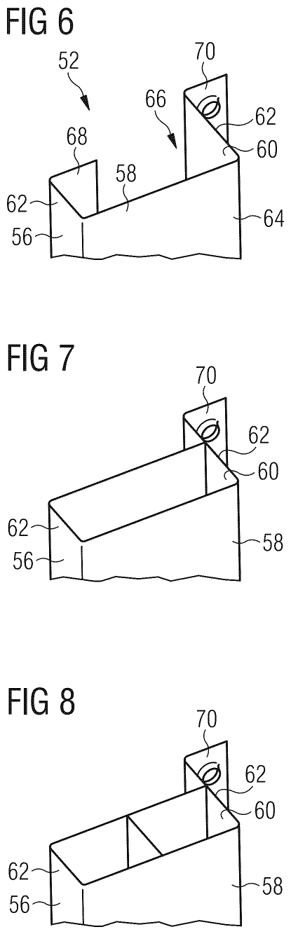

Referring to FIG. 4 and FIG. 6, the case sheet member 52 generally has a U-shaped cross-section formed of the leg portions 56-60. The three leg portions 56-60 form sidewalls 62 and a channel bottom 64 of a channel 66 that is open to one side.

The case sheet member 52 may have a first flange 68 that protrudes from one of the sidewalls 62 towards the other sidewall thereby partially covering the opening. The first flange 68 allows fastening of the case sheet member 52 to the cover sheet member 54 and/or to the column bracket 44.

The case sheet member 52 may include a second flange 70 that protrudes from the other of the sidewalls 62 outwards and away from the channel 66. The second flange 70 allows fastening of the case sheet member 52 to support rails 72 that support the energy storage modules 14.

Referring back to FIG. 4, the cover sheet member 54 has two orthogonal leg portions 74, 76. The leg portion 74 is large enough to cover the channel 66 so that the case sheet member 52 and the cover sheet member 54 form a hollow profile. The leg portion 74 can be fastened to the first flange 68 and/or to the column bracket 44.

As shown in FIG. 4, two neighboring columns 22 may be fastened to a single column bracket 44 such that their respective case sheet members 52 are in contact with each other, preferably with their respective channel bottoms 64.

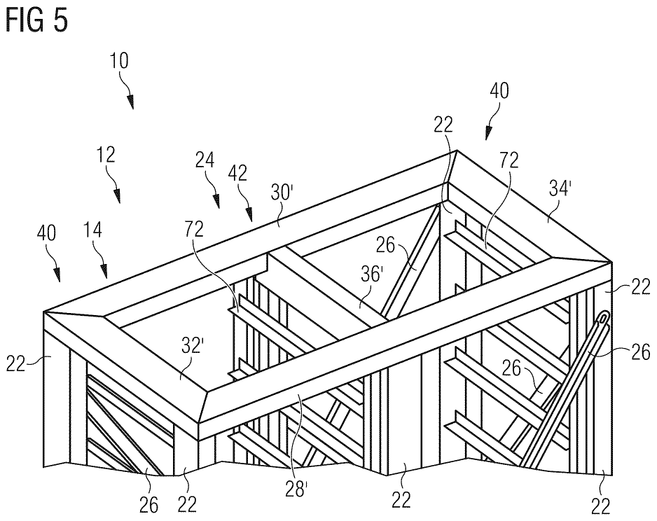

Referring to FIG. 5, the top frame 24 is matched to the bottom frame 20 such that the columns 22 are vertical in the installed stated. Thus, the configuration of the top frame 24 is not described again for sake of brevity. It is noted that the same reference signs are used as with the bottom frame, however, with an added apostrophe. The top frame 24 can be made of separate metal profiles or bent sheet metal that are bolted together, or the top frame 24 can be integrally formed by welding bent sheet metal or metal profiles.

Referring to FIG. 7, the column 22 can also be integrally formed as a single member hollow profile with a rectangular cross-section.

Referring to FIG. 8, the column 22 may include a reinforcement that is arranged within the hollow profile.

Applicant has found through FEM-simulations that the described frame structure 12 meets the vibrational requirements set forth in the abovementioned standard.

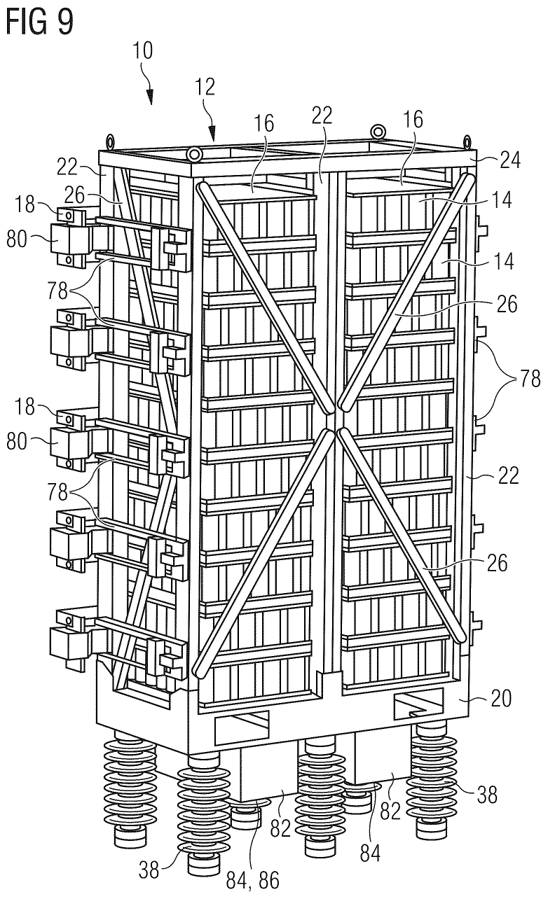

Referring to FIG. 9 another embodiment of an energy storage rack 10 is described insofar as it differs from the previously described embodiment. The energy storage rack 10 comprises a plurality of structural braces 78. The structural braces 78 are disposed on a side of the energy storage rack 10. Each structural brace 78 spans at least two columns 22 (front and back). The structural braces 78 are made of bent sheet metal.

The energy storage rack 10 comprises a plurality of busbars 18 that are disposed on the front and electrically connect the energy storage modules 14. The busbars 18 are preferably supported by pylons 80 that are attached to a single column 22.

The energy storage rack 10 may further comprise at least one installation position 82. The installation positions 82 are disposed below the bottom frame 20. The installation positions 82 may be formed by sheet metal. Each installation position 82 may an auxiliary power module 84 and/or a rack controller unit 86. The auxiliary power module 84 is configured to supply the controllers (module controller units and rack controller unit 86) of the energy storage rack 10 in case of a main power outage. The rack controller unit 86 is configured to control the module control units in order to form a manageable system.

The installation position 82 are disposed within the volume below the bottom frame 20 and in between the HV isolators 38.

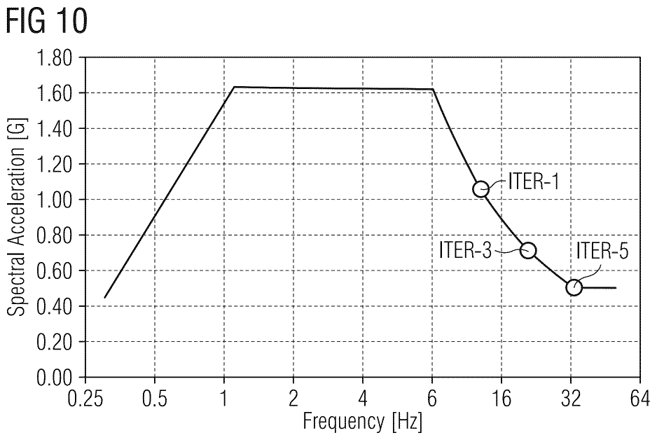

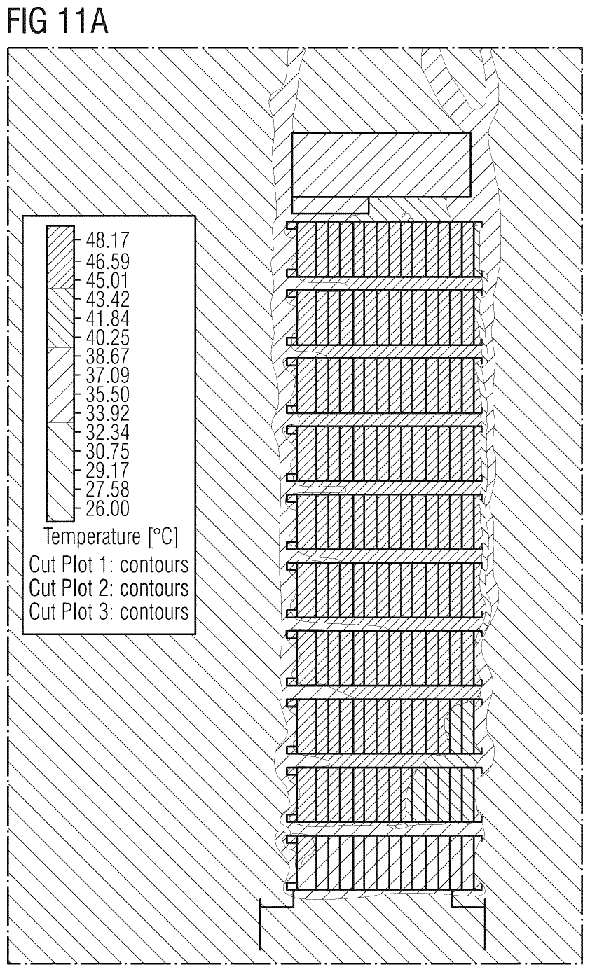

Referring to FIG. 10, a spectral acceleration graph is illustrated. The x-axis is the frequency and the y-axis denotes the acceleration in multiples of the earth acceleration of about 9.8 m/s². The line shows the frequency sweep using sine waves and their amplitude. The data point ITER-1 depicts the result for an energy storage rack without integral bottom frame and 20 modules as a comparison. This is non-compliant with the seismic standard. Data point ITER-3 shows the energy storage rack 10 with an integral bottom frame 20 and four HV isolators 38 with significant improvement in seismic behavior. Data point ITER-5 shows the energy storage rack 10 with integral bottom frame 20 and six HV isolators 38 with still further improvement in seismic behavior.

In some embodiments the mechanical rack comprises multiple energy storage modules. The modules can be comprised of supercapacitor or hybrid battery cells. In some embodiments the vibration profile of the proposed rack is below 33 Hz. Thus, the rack design complies with seismic requirements according to IEEE 693:2018 moderate-level seismic input with 2% damping. In some embodiments the rack comprises a welded beam base frame. In some embodiments the rack features diagonal supports at the back and on both sides, with none on the front side. In some embodiments the rack height is kept at the minimum by moving all supplementary equipment to the sides and/or below the framework. In some embodiments there are no single-purpose steel components; ideally all components work toward strengthening the whole structure. In some embodiments the rack is installed on multiple, e.g. six, HV insulators-one at each corner of the rack and two under the mid-section of the double rack. In some embodiments the proposed rack includes a passive cooling mechanism that evenly distributes heat, preventing localized overheating and ensuring the reliability and longevity of electronic components within the electric storage system (ESS). In some embodiments the temperature distribution has a consistent gradient throughout the rack. The energy storage rack is seismic hazard proof and generally complies with the IEEE 693:2018 seismic profile standards. Apart from its earthquake-proof design, the rack may also comprise natural cooling and preferably has no enclosure.

The rack is able to prevent seismic hazard and is most suitable in HVDC systems, especially in static synchronous compensator (STATCOM) or enhanced-STATCOM (ESTACOM) systems. One rack unit preferably is composed as a double rack containing multiple, e.g., ten to twenty, energy storage modules, master (module) controllers, a bypass subassembly, an auxiliary (“aux.”) supply, and/or rack controller equipment.

The rack unit framework dimensions are about 1200×600×2100 (W×D×H each in mm, excl. insulators). ESS modules are designed to be installed in the rack with typical 19-inch slider spacing. This is generally the major constraint that determines the overall rack dimensions. The framework is preferably designed to fit twenty ESS modules. The modules can be installed on slidable brackets and are generally fixed with screws at the front face. The framework includes two major subassemblies-a welded base frame and a sheet metal framework. It is preferably an open rack with no walls. The rack is generally capped at an IP00 protective rating, i.e. a level of protection where there is no special protection against solids or liquids.

The rack concept is highly compact and generally features no additional or optional empty space that is not filled with the required equipment. In order to better comply with the seismic profile, the height of the rack is ideally kept to a minimum. Additionally or alternatively all supplementary equipment is installed on the sides and/or below the rack. Keeping the rack height to a minimum also allows to improve potential logistics issues like transportation limitations and maintainability (e.g., less equipment to reach with a mobile platform). The rack is preferably installed on six HV insulators-one at each corner of the rack and two under the mid-section of the double rack. The auxiliary power system and rack controller are preferably installed underneath the rack base frame between the HV insulators. Applicant found in their FEM studies that this was the best location in view of seismic considerations.

The master controller generally performs the voltage balancing of the cells within the rack. It can be installed either at the very top or bottom of the rack, preferably in the slot mounting positions. The master controller is preferably at the very top. In the double-track system, the auxiliary supply units are preferably placed below the rack due to seismic design and stability considerations. The grounding point, which is to be used during maintenance, is preferably located at the center of the base frame.

The seismic design considerations involve enhanced stability preferably, by placing the auxiliary units below the system center of gravity. This helps to improve stability and resistance to seismic activity.

In general, the E-STATCOM system is designed to withstand the moderate profile of the IEEE 693:2018 seismic profile.

In order to design the rack to comply with the standard, a series of preliminary seismic-specific simulations were performed. Two simulation targets were set in accordance with the standard tests. The first target is that the lowest eigenfrequency in the horizontal direction is above 33 Hz. In case there is an eigenfrequency in the vertical direction below 33 Hz, the design is still acceptable. The eigenfrequency should match the requirements of IEEE 693-2018, otherwise, the vibration load can get amplified, leading to potentially destructive resonance events.

The second target is that no failure must be seen at the rack regarding the provided vibration profile. The vibration profile exists below 33 Hz. Any resonance below 33 Hz will generally amplify the seismic input. The simulation results show that the rack design complies with seismic requirements according to IEEE 693:2018 moderate-level seismic input with 2% damping. No damage is observed with the sine-sweep fatigue calculation.

The best-performing design iteration of the rack framework involves at least one of the following features:
an integral, e.g., welded, beam base frame;
diagonal struts at the back and/or sides of the framework;
at least four, preferably six HV insulators;
rack height is kept at a minimum by moving most or all supplementary equipment to the sides and/or below the framework;
all components work toward strengthening of the whole structure;
Furthermore, a thermal management design was found by simulations.

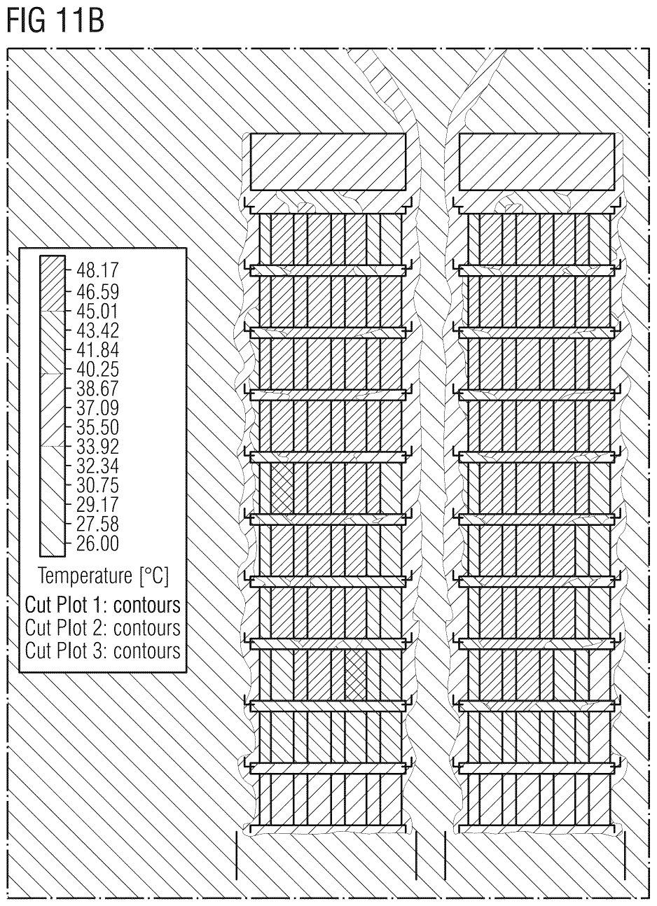

The results are shown in FIG. 11 to FIG. 13. The primary goal of the thermal simulation is to evaluate the effectiveness of the cooling concept for the E-STATCOM (double) rack design. Efficient thermal management is crucial for ensuring the reliability and longevity of electronic components within the ESS. The simulation showed that passive cooling methods are sufficient. For the simulation, the simplified rack model was used to reduce the simulation time.

The objective of the simulations is the investigation of the feasibility of the targeted passive cooling concept. Analysis conditions are as follows:
Simplified double rack model for simulation.
Module count: 20×ESS modules.
Master Controller and Switchgear enclosures included (on top) for worst-case air movement restriction.
Load: ESS modules only −31 A rms.
Module balancer temperature: 85° C.
Module power loss: 16.49 W (Cells and busbars only, balancer excluded).
Module at EoL (End of life) conditions, ESR (200% of rated Is ESR) (Equivalent series resistance).
Total power loss of the rack: 15.4×20=308 W (Cells and busbars only, balancers excluded)
Ambient temperature: 26° C.
Cooling type: Natural convection
Temperature criteria: Maximum cell temperature is used
Rack IP class: IP00

As shown in FIG. 11A and FIG. 11B, the thermal simulation results indicate the temperature distribution within the E-STATCOM double-rack design under the specified conditions. The temperature distribution within the double rack reveals a consistent gradient, with the highest temperatures occurring near the top of the rack due to natural convection.

The maximum cell temperature observed was around 48° C., which is within the acceptable operational limits for the components. This shows that the passive cooling concept is sufficient to manage the heat generated by the ESS modules. The simulated temperatures show relatively uniform distribution across the modules, with no significant hotspots. This indicates that the passive cooling mechanism distributes heat evenly, preventing localized overheating. It should be noted, that the ESS module electronics PCB at the front has an initially set temperature of 85° C.

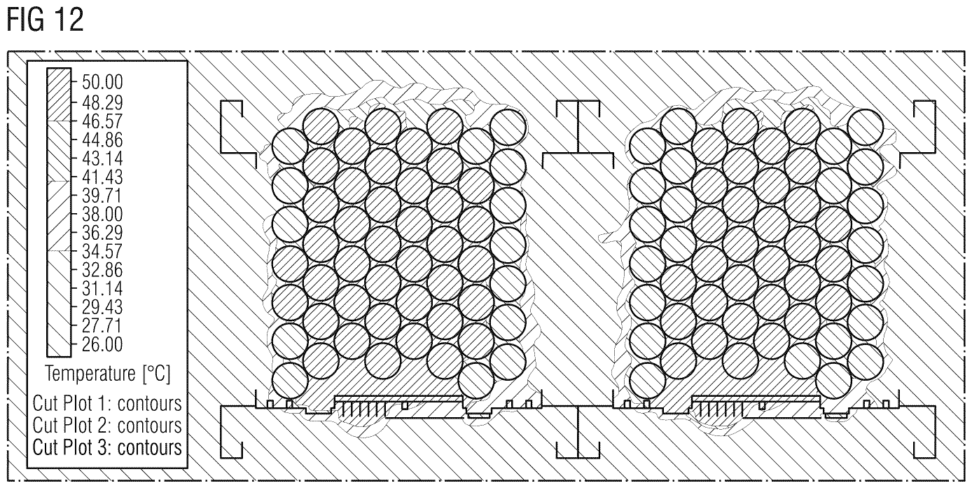

FIG. 12 depicts a detailed analysis of individual modules, particularly the third module from the top, and shows a higher temperature at the center compared to the edges. This core-to-edge gradient is typical this setup, but can be managed within safe limits.

The lifetime simulations conducted after thermal simulations demonstrate that the current cooling configuration for the E-STATCOM double-rack design is effective. The study is generally focused on assessing the temperature rise within the modules and the thermal resistance (Rₜₕ).

Key findings from the thermal study are discussed for temperature rise, thermal resistance, and lifetime expectation. The maximum cell temperature observed during the simulations was around 48° C. This temperature is well within the acceptable operational limits for the components. The thermal simulations revealed the highest thermal resistance (Rₜₕ) value of 1.34 K/W. This value is indicative of efficient heat dissipation, with the system effectively managing the thermal load generated by the modules. The Rₜₕ value used in lifetime simulations is chosen according to the highest module temperature value. Based on the temperature rise and the calculated thermal resistance, the expected lifetime of the system components is about 20 years with ambient temperature at 26° C.

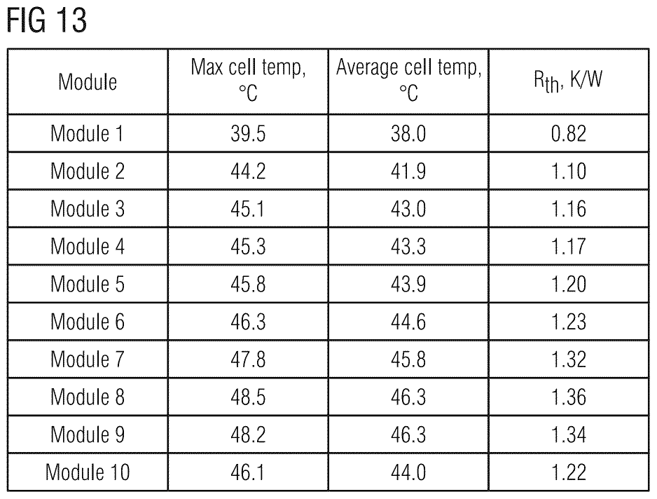

FIG. 13 shows temperature values and Rₜₕ values from the thermal simulation. Module 8 has the highest max temperature value recorded and taken as a basis for lifetime simulations. Numbering is from the lowest module to the highest in the rack. (Module One—Bottom-most module in the rack; Module Ten—Top-most module in the rack)

In the double-rack design, precise temperature monitoring is helps ensuring the optimal performance and longevity of the modules. The placement of temperature sensors is strategically designed to capture accurate thermal data from critical points within the system. The sensors are placed on the printed circuit board (PCB) rather than directly on the monitored cells themselves.

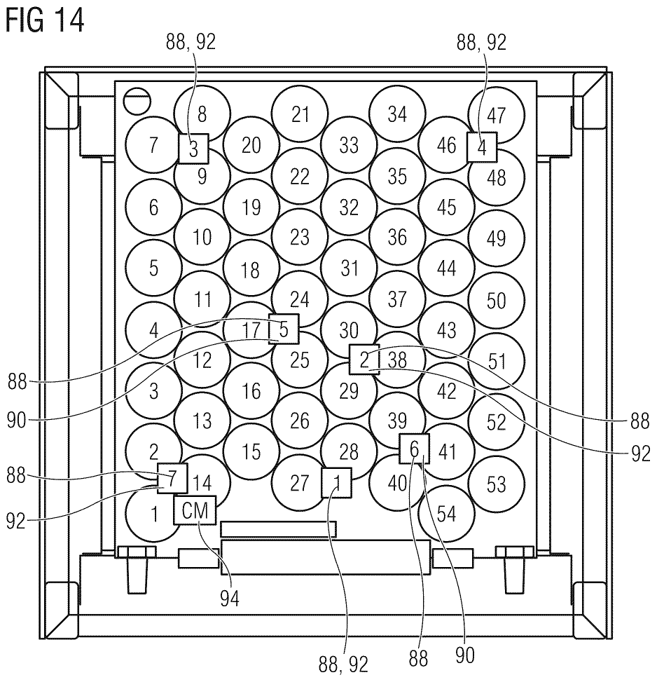

As depicted in FIG. 14, each cell is numbered from 1 to 54 (not to be confused with the reference numerals), and temperature sensors 88 are positioned at key locations to monitor the thermal state. Specifically, bottom-side temperature sensors 90 and top-side temperature sensors 92 are used. The CM sensor 94 is for the current measurement of the PCB busbar.

Given the effective thermal management demonstrated by the simulations, the current configuration of the double-track design does not require additional cooling. The passive cooling method, utilizing natural convection, is considered sufficient to maintain safe operating temperatures, thereby ensuring the longevity and availability of the electronic components.

The decision to use IP00 class enclosures is further justified by their cost-effectiveness, optimal cooling efficiency, reduced complexity, and achieved a lifetime of 20 years. Additional costs, added weight, operational complexities, and potential environmental impacts are avoided by using natural convection cooling instead of forced or liquid cooling solutions. This can further reduce the failure rates as the aforementioned cooling solutions have additional failure modes that can be avoided. This approach allows for a reliable, efficient, and sustainable thermal management solution rack systems.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

10 energy storage rack
12 frame structure
14 energy storage modules
16 mounting position
18 busbar
20 bottom frame
22 columns
24 top frame
26 truss
28 front portion (bottom frame)
28′ front portion (top frame)
30 back portion (bottom frame)
30′ back portion (top frame)
32 side portion (bottom frame)
32′ side portion (top frame)
34 side portion (bottom frame)
34′ side portion (top frame)
36 crossbeam (bottom frame)
36′ crossbeam (top frame)
37 stabilization plates
38 high-voltage (HV) isolators
40 corner portion
42 intermediate portion
44 column bracket
46 first leg portion
48 second leg portion
50 third leg portion
52 case sheet member
54 cover sheet member
56 leg portion
58 leg portions
60 leg portion
62 sidewall
64 channel bottom
66 channel
68 first flange
70 second flange
72 support rail
74 leg portion
76 leg portion
78 structural brace
80 pylon
82 installation position
84 auxiliary power module
86 rack controller unit
88 temperature sensor
90 bottom-side temperature sensor
92 top-side temperature sensors
94 CM sensor

1. A cuboidal frame structure configured for absorbing, or damping, or absorbing and damping seismic vibration, the cuboidal frame structure configured for an energy storage rack of an energy storage system, the cuboidal frame structure comprising:
a bottom frame integrally formed as a single member, the bottom frame having a plurality of column brackets that protrude in a vertical direction upward and are configured for aligning a column in parallel to a vertical direction;
a plurality of columns, the plurality of columns mounted to the bottom frame via the plurality of column brackets, each column of the plurality of columns formed as a hollow profile; and,
a top frame mounted to each column or the plurality of columns,
wherein the plurality of columns cooperatively provide a plurality of mounting positions configured for receiving and mounting energy storage modules.

2. The cuboidal frame structure of claim 1, wherein the bottom frame is integrally formed by welding a plurality of components or by casting.

3. The cuboidal frame structure of claim 1, wherein each column of the plurality of columns is attached to the bottom frame, or to the top frame, or to both by a plurality of bolt fasteners.

4. The cuboidal frame structure of claim 1, wherein the top frame is integrally formed as a single member.

5. The cuboidal frame structure of claim 1, wherein at least one first column bracket of the plurality of column brackets has a first leg portion that extends in parallel to a shorter side of the bottom frame and a second leg portion that extends in parallel to a longer side of the bottom frame, and
wherein the first leg portion and the second leg portion are in contact with, or fastened, or both in contact with and fastened to a respective column of the plurality of columns.

6. The cuboidal frame structure of claim 5, wherein the at least one first column bracket is formed at a corner portion of the bottom frame.

7. The cuboidal frame structure of claim 5, wherein at least one second column bracket from the plurality of column brackets is formed at an edge portion of the bottom frame,
wherein the at least one second column bracket includes a third leg portion that extends parallel to the first leg portion with a space there between,
wherein two columns of the plurality of columns are fastened to the first column bracket and the second column bracket such that at least one of the two columns engages the first leg portion and the third leg portion.

8. The cuboidal frame structure of claim 1, wherein at least one column of the plurality of columns includes a case sheet member and a cover sheet member for engaging, or fastening, or both to each other to form the at least one column.

9. The cuboidal frame structure of claim 8, wherein the case sheet member comprises at least three leg portions that are bent in a U-configuration to form sidewalls and a channel bottom of a channel,
wherein the cover sheet member comprises at least two leg portions that are bent in an L-configuration and the cover sheet member closes the channel to form the hollow profile, and
wherein, optionally, the case sheet member includes a flange portion that partially protrudes from one sidewall inward and parallel to the channel bottom.

10. The cuboidal frame structure of claim 1, wherein at least one column of the plurality of columns is integrally formed as a single member.

11. The cuboidal frame structure of claim 10, wherein the at least one column includes a reinforcement portion that extends parallel to a short side of the at least one column in a cross-sectional view.

12. The cuboidal frame structure of claim 1, further comprising:
at least one truss member fastened to an end portion of a first column of the plurality of columns and to an end portion or a middle portion of a second column of the plurality of columns to form an acute angle with the first column and the second column.

13. The cuboidal frame structure of claim 1, further comprising:
a plurality of high-voltage isolators fastened to the bottom frame.

14. The cuboidal frame structure of claim 1, further comprising:
at least one installation position that is disposed below the bottom frame and is configured for receiving and installing an auxiliary power module configured for providing auxiliary power in case of a main power outage, or a rack controller unit that is configured to control energy storage modules, or both.

15. An energy storage rack for an energy storage system, the energy storage rack comprising:
the frame structure of claim 1; and
a plurality of energy storage modules configured for storing and providing electrical power,
wherein the energy storage modules are mounted on mounting positions provided by the frame structure.

16. The energy storage rack of claim 15, wherein the plurality of energy storage modules include an energy storage that involves supercapacitors.

17. The energy storage rack of claim 15, wherein the frame structure includes at least one installation position that is disposed below the bottom frame, and wherein the energy storage rack further comprising:
at least one auxiliary power module, or at least one rack controller unit, or both installed at the at least one installation position.

18. The energy storage rack of claim 15, wherein the plurality of energy storage modules are passively cooled.

19. The energy storage rack of claim 18, wherein each energy storage module of the plurality of energy storage modules includes a plurality of energy storage cells arranged in a pattern of hexagonally close-packed equal cylinders or in a rectangular pattern.

20. The energy storage rack of claim 18, wherein an energy storage module of the plurality of energy storage modules includes a heat sink disposed at an outward facing side of the energy storage module.
